(19) United States
(12) Patent Application Publication
(10) Pub. No.: US 2020/0140722 A1
(43) Pub. Date: May 7, 2020

(54) CURABLE COMPOSITIONS

(71) Applicant: 3M INNOVATIVE PROPERTIES COMPANY, St. Paul, MN (US)

(72) Inventors: Steven C. Hackett, Oakdale, MN (US); Brett A. Beiermann, St. Paul, MN (US); Ambuj Sharma, St. Paul, MN (US); Howard S. Creel, Oakdale, MN (US); Wendy L. Thompson, Roseville, MN (US)

(21) Appl. No.: 16/473,415

(22) PCT Filed: Dec. 20, 2017
(86) PCT No.: PCT/US17/67491

§ 371 Date: Jun. 25, 2019

Related U.S. Application Data
(60) Provisional application No. 62/439,983, filed on Dec. 29, 2016.

(51) Int. Cl. C09J 7/25; C09J 11/08; C09J 11/04

(52) U.S. Cl. CPC C09J 7/25; C09J 11/08; C09J 2205/11; C09J 2400/123; C09J 2463/006; C09J 11/04

(57) ABSTRACT

Provided are curable compositions that include an epoxy resin; a 9,9-bis(aminophenyl)fluorene or derivative therefrom; and core shell particles, each comprising an elastomeric core and a polymeric outer shell layer coated on the elastomeric core. The core shell particles can be at least partially aggregated with each other, include polymeric intermediate layers between the core and outer shell layers, and/or have a multimodal particle diameter distribution. The curable compositions may also optionally include inorganic sub-micron particles dispersed in the curable composition, the inorganic sub-micron particles having surface-bonded organic groups that compatibilize the inorganic sub-micron particles and the epoxy resin.

### FIELD OF THE INVENTION

Provided are curable compositions. The provided curable compositions include those suitable for use in fiber composites and other aerospace applications.

### BACKGROUND

Certain industrial and commercial applications demand curable resins that provide robust mechanical properties in extreme environments. Examples of such applications include adhesives, coatings, underfill compositions, and matrix materials. Curable resins known in the art are generally derived from phenolic resins, unsaturated polyester resins, and epoxy resins. By virtue of being curable, these resins can be coated, molded or otherwise shaped for end use in structural applications prior to being cured or otherwise hardened.

Some especially challenging structural applications reside in the field of matrix materials for high performance composites. Composite materials are becoming increasingly prevalent in general aviation and aerospace applications on account of their high weight-to-strength ratios. Common uses are in primary and secondary structures and interior composite applications, including nacelles, flaps, flooring, storage bins, and door and window interiors.

Certain applications demand resins that are lightweight, tough, and can tolerate extreme heat and pressure fluctuations as encountered at high altitudes. Fan containment cases, for example, require extreme toughness to prevent stray fan blade fragments from escaping the engine and potentially damaging the fuselage of the aircraft. To meet specifications for airworthiness, such materials generally also need to be fire resistant.

Formulating the curable resin to obtain the requisite toughness for these applications remains a substantial technical challenge. One route to improving toughness uses specialized fluorene amine curing agents that increase glass transition temperature while avoiding high levels of crosslinking. Fluorene curing agents can enable matrix resins that display both high hot-wet service temperatures and high impact resistance.

### SUMMARY

Fluorene amine curing agents tend to result in low melt viscosity of resin systems that use these curing agents. The tendency for the resin to flow during cure can be exploited in resin transfer molding processes, which are useful in fabricating carbon fiber composites. These resin systems can display high impact resistance, particularly with the addition of embedded particulate rubber tougheners.

Notwithstanding these advantages, the service temperature of these curable resins can be limiting in certain high temperature applications, such as for components in jet engines. While these resins may still be used in some cases, insulation may be needed to protect components made from these resins. This problem can be overcome by using a curable resin in which an epoxy resin is mixed with a 9,9-bis(aminophenyl) fluorene-based curing agent and synergistic particulate tougheners. Useful particulate tougheners include, for example, core shell particles that have an elastomeric core, an intermediate layer having two or more double bonds, and a shell layer, each component of the core shell particles being chemically bonded to its neighboring component(s).

Advantageously, the maximum loading of these core shell particles was found to be enhanced by the presence of the 9,9-bis(aminophenyl) fluorene-based curing agent, resulting in improved fracture toughness. As a further option, inorganic sub-micron particles may be dispersed in the epoxy resin to further enhance the strength of composite materials derived therefrom.

In one aspect, a curable composition is provided. The curable composition comprises: epoxy resin; a 9,9-bis(aminophenyl) fluorene or derivative therefrom; and core shell particles, each comprising an elastomeric core and a polymeric outer shell layer coated on the elastomeric core; wherein the core shell particles are at least partially aggregated with each other.

In a second aspect, a curable composition is provided, comprising: epoxy resin; a 9,9-bis(aminophenyl) fluorene or derivative therefrom; and core shell particles, each comprising an elastomeric core and a polymeric outer shell layer disposed on the elastomeric core; wherein the core shell particles have a multimodal particle diameter distribution.

In a third aspect, a curable composition is provided, comprising: epoxy resin; a 9,9-bis(aminophenyl) fluorene or derivative therefrom; and core shell particles, each comprising: an elastomeric core; a polymeric intermediate layer disposed on the elastomeric core; and a polymeric outer shell layer disposed on the polymeric intermediate layer, the polymeric outer shell layer having a greater degree of unsaturation than that of the polymeric intermediate layer.

In a fourth aspect, a curable composition is provided, comprising: epoxy resin; a 9,9-bis(aminophenyl) fluorene or derivative therefrom; core shell particles, each comprising an elastomeric core and a polymeric outer shell layer coated on the elastomeric core; and inorganic sub-micron particles dispersed in the curable composition, the inorganic sub-micron particles having surface-bonded organic groups that compatibilize the inorganic sub-micron particles and the epoxy resin.

In a further aspects, cured compositions and derivatives therefrom are obtained by curing any of the aforementioned curable compositions.

### Definitions

The term “amino” refers to a chemical group containing a basic nitrogen atom with a lone pair (—NHR), and may be either a primary or secondary chemical group.

The term “average” generally refers to a number average but may, when referring to particle diameter, either represent a number average or volume average.

The term “cure” refers to exposing to radiation in any form, heating, or allowing to undergo a physical or chemical reaction that results in hardening or an increase in viscosity. Thermoset materials can be cured by heating or otherwise exposing to irradiation such that the material hardens.

The term “particle diameter” represents the largest transverse dimension of the particle.

The term “halogen” group, as used herein, means a fluorine, chlorine, bromine, or iodine atom, unless otherwise stated.

The term “sub-micron particles” refers to particulate filler having an average diameter of less than 1 micrometer (which can include nanoparticles having an average diameter of less than 100 nanometers).

The term “polymer” refers to a molecule having at least one repeating unit and can include copolymers.

The term “substituted” as used herein in conjunction with a molecule or an organic group as defined herein refers to the state in which one or more hydrogen atoms contained therein are replaced by one or more non-hydrogen atoms. The term “functional group” or “substituent” refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups.

### BRIEF DESCRIPTION OF THE DRAWINGS

The disclosure may be more completely understood in consideration of the following detailed description of various embodiments of the disclosure in connection with the accompanying figures.

FIGS. 1-3 are bright-field image transmission electron micrographs showing cured compositions according various exemplary embodiments. Each composition was previously stained with osmium tetroxide (OsO₄) for contrast.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

The terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

### Curable Compositions

### Epoxy Resins

Epoxy resins are monomers or prepolymers capable of reacting with a suitable curing agent to yield a hardened resin. These resins are useful as matrix resins fiber-reinforced composites and other structural applications because of their combination of thermal and chemical resistance, adhesion and abrasion resistance.

The provided curable resins include one or more epoxy resins. Epoxy resins are characterized by the presence of a 3-member cyclic ether group commonly referred to as an epoxide group. The epoxy resin may contain more than one epoxide group, in which case it is referred to as a polyepoxide. Epoxy resins may be saturated or unsaturated, aliphatic, alicyclic, aromatic, or heterocyclic, or any combination thereof. The epoxy resins are cured, or hardened, by the addition of a curing agent. Known curing agents include anhydrides, amines, polyamides, Lewis acids, salts and others.

Aromatic polyepoxides can be particularly useful based on their robustness at high temperatures. Aromatic polyepoxides are compounds in which there is present at least one aromatic ring structure, e.g. a benzene ring, and more than one epoxy group.

Useful aromatic polyepoxides can contain at least one aromatic ring (e.g., phenyl group) that is optionally substituted by a halogen, alkyl having 1 to 4 carbon atoms (e.g., methyl or ethyl), or hydroxyalkyl having 1 to 4 carbon atoms (e.g., hydroxymethyl). In some embodiments, the aromatic polyepoxide contains at least two or more aromatic rings and in some embodiments, can contain 1 to 4 aromatic rings. For polyepoxides and epoxy resin repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo).

In some embodiments, the aromatic polyepoxide or epoxy resin is a novolac. In these embodiments, the novolac epoxy may be a phenol novolac, an ortho-, meta-, or para-cresol novolac, or a combination thereof. In some embodiments, the aromatic polyepoxide or epoxy resin is a bisphenol diglycidyl ether, wherein the bisphenol (i.e., —O—C₆H₅—CH₂—C₆H₅—O—) may be unsubstituted, or either of the phenyl rings or the methylene group may be substituted by halogen (e.g., fluoro, chloro, bromo, iodo), methyl, trifluoromethyl, or hydroxymethyl. In some embodiments, the polyepoxide is a novolac epoxy resin (e.g., phenol novolacs, ortho-, meta-, or para-cresol novolacs or combinations thereof), a bisphenol epoxy resin (e.g., bisphenol A, bisphenol E, bisphenol F, halogenated bisphenol epoxies, fluorene epoxies, and combinations thereof), a resorcinol epoxy resin, and combinations of any of these. Examples of useful aromatic monomeric polyepoxides include the diglycidyl ethers of bisphenol A and bisphenol F and tetrakis glycidyl-4-phenylolethane and combinations thereof.

Useful aromatic polyepoxides also include polyglycidyl ethers of polyhydric phenols, glycidyl esters of aromatic carboxylic acid, N-glycidylaminobenzenes, and glycidylamino-glyclidyloxy-benzenes. The aromatic polyepoxides can be the polyglycidyl ethers of polyhydric phenols.

Examples of aromatic polyepoxides include the polyglycidyl derivatives of polyhydric phenols such as 2,2-bis-[4-(2,3-epoxypropoxy)phenyl]propane and those described in U.S. Pat. No. 3,018,262 (Schroeder) and U.S. Pat. No. 3,298,998 (Coover et al.), and in “Handbook of Epoxy Resins” by Lee and Neville, McGraw-Hill Book Co., New York (1967). A preferred class of polyglycidyl ethers of polyhydric phenols described above are diglycidyl ethers of bisphenol that have pendent carbocyclic groups. Examples of such diglycidyl ethers are 2,2-bis[4-(2,3-epoxypropoxy)phenyl]norcamphane and 2,2-bis[4-(2,3-epoxypropoxy)phenyl]decahydro-1,4,5,8-dimethanonaphthalene A preferred diglycidyl ether is 9,9-bis[4-(2,3-epoxypropoxy)phenyl]fluorene.

The epoxy resin can be any proportion of the curable composition suitable to obtain the desired impact resistance after the composition is cured. In some embodiments, the epoxy resin represents from 30 wt % to 60 wt %, 40 wt % to 55 wt %, or 45 wt % to 50 wt % of the curable composition, or in some embodiments, less than, equal to, or greater than 30 wt %, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt % of the curable composition.

### Curing Agents

The provided curable compositions include at least one curing agent. The provided curing agents can afford a composition that is thermally curable. In other words, the curable composition does not cure at room temperature but cures at elevated temperatures. Advantageously, the provided curing agents can be used to prepare a resin having both high ductility and a high glass transition temperature.

In certain applications, the provided curing agents can afford a cured composition that displays not only a high glass transition temperature but also a low degree of moisture pick-up. In some embodiments, the cured resin does not exhibit a substantial reduction in glass transition temperature even in the event there is some absorption of moisture.

The curing agent of use in the curable composition comprises at least one 9,9-bis(aminophenyl)fluorene or derivative therefrom. The phenyl and benzo groups of the 9,9-bis(aminophenyl)fluorene or derivative therefrom can be unsubstituted or substituted by one or more atoms or groups inert to reaction with an epoxide group.

In some embodiments, the curing agent has the chemical structure:

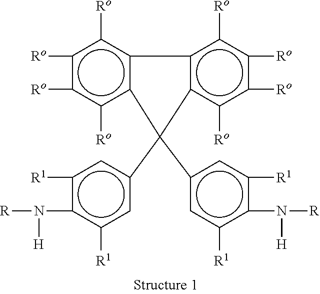

wherein each R^{o} is independently selected from hydrogen and groups that are inert in the polymerization of epoxide group-containing compounds, preferably selected from halogen, linear and branched alkyl groups having 1 to 6 carbon atoms, phenyl, nitro, acetyl and trimethylsilyl; each R is independently selected from hydrogen and linear and branched alkyl groups having 1 to 6 carbon atoms; and each R¹ is independently selected from R, hydrogen, phenyl, and halogen.

In some embodiments, the epoxy resin compositions can include one or more polyglycidyl ethers of polyhydric phenols and at least one 9,9-bis(aminophenyl)fluorene or derivative therefrom. Optionally, the epoxy resin composition further contains a sufficient amount of a conventional curing agent for epoxy resins, such as a polyamino group-containing compound and/or a conventional epoxy resin curing catalyst.

In an exemplary embodiment, the curable composition of the invention includes an aromatic polyepoxide, which is optionally a poly(glycidyl ether) of a polyhydric phenol, and a curing agent, or a mixture of curing agents, containing amino (i.e., —NHR) groups. At least some of the amino groups are provided by a 9,9-bis(aminophenyl)fluorene or derivative therefrom having Structure I above, wherein each R^{o} is independently selected from hydrogen and groups inert in the polymerization of epoxide group-containing compounds, optionally selected from halogen, linear and branched alkyl groups having 1 to 6 carbon atoms, phenyl, nitro, acetyl and trimethylsilyl, each R is independently selected from hydrogen and linear and branched alkyl groups having 1 to 6 carbon atoms of which at least 25 mole percent of R is linear or branched alkyl, and each R¹ is independently selected from hydrogen, linear and branched alkyl groups having one to six carbon atoms, phenyl, or halogen groups.

As a further option, the curable composition can include a second curing agent. The second curing agent can be selected for example from aliphatic polyamines, aromatic polyamines, aromatic polyamides, alicyclic polyamines, polyamines, polyamides, and amino resins. In some embodiments, the second curing agent is 9,9-bis(4-aminophenyl)fluorene.

Advantageously, the stoichiometric ratio of curing agent to aromatic polyepoxide can be used to control the crosslink density of the cured epoxy composition. Resins having reduced crosslink density are desirable because they are exceptionally ductile and can be rubber toughened by the addition of core shell particles as described herein. Further details concerning fluorene curing agents are described in U.S. Pat. No. 4,684,678 (Schultz et al.).

Examples of 9,9-bis(aminophenyl)fluorene derivatives include: 9,9-bis(4-aminophenyl)fluorene, 4-methyl-9,9-bis(4-aminophenyl)fluorene, 4-chloro-9,9-bis(4-aminophenyl)fluorene, 2-ethyl-9,9-bis(4-aminophenyl)fluorene, 2-iodo-9,9-bis(4-aminophenyl)fluorene, 3-bromo-9,9-bis(4-aminophenyl)fluorene, 9-(4-methylaminophenyl)-9-(4-ethylaminophenyl)fluorene, 1-chloro-9,9-bis(4-aminophenyl)fluorene, 2-methyl-9,9-bis(4-aminophenyl)fluorene, 2,6-dimethyl-9,9-bis(4-aminophenyl)fluorene, 1,5-dimethyl-9,9-bis(4-aminophenyl)fluorene, 2-fluoro-9,9-bis(4-aminophenyl)fluorene, 1,2,3,4,5,6,7,8-octafluoro-9,9-bis(4-aminophenyl)fluorene, 2,7-dinitro-9,9-bis(4-aminophenyl)fluorene, 2-chloro-4-methyl-9,9-bis(4-aminophenyl)fluorene, 2,7-dichloro-9,9-bis(4-aminophenyl)fluorene, 2-acetyl-9,9-bis(4-aminophenyl)fluorene, 2-methyl-9,9-bis(4-methylaminophenyl)fluorene, 2-chloro-9,9-bis(4-ethylaminophenyl)fluorene, 2-t-butyl-9,9-bis(4-methylaminophenyl)fluorene, 9,9-bis(3-methyl-4-aminophenyl)fluorene, and 9-(3-methyl-4-aminophenyl)-9-(3-chloro-4-aminophenyl)fluorene.

Useful curing agents include bis(secondary-aminophenyl)fluorenes or a mixture of the bis(secondary-aminophenyl)fluorenes and a (primary-aminophenyl)(secondary-aminophenyl)fluorene.

Other useful curing agents include sterically hindered bis(primary-aminophenyl)fluorenes. When hindered amines or mixtures of such hindered amines with the secondary amines above are used as the curing agent for epoxy resin compositions comprising poly(glycidyl ethers) of polyhydric phenols, these compositions can have a thermal stability (or latency) of at least three weeks and cure to cured resins having a high glass transition temperature and a water pick-up of less than about 3 percent by weight.

Examples of hindered amines include 9,9-bis(3-methyl-4-aminophenyl)fluorene, 9,9-bis(3-ethyl-4-aminophenyl)fluorene, 9,9-bis(3-phenyl-4-aminophenyl)fluorene, 9,9-bis(3,5-dimethyl-4-methylaminophenyl)fluorene, 9,9-bis(3,5-dimethyl-4-aminophenyl)fluorene, 9-(3,5-dimethyl-4-methylaminophenyl)-9-(3,5-dimethyl-4-aminophenyl)fluorene, 9-(3,5-diethyl-4-aminophenyl)-9-(3-methyl-4-aminophenyl)fluorene, 1,5-dimethyl-9,9-bis(3,5-dimethyl-4-methylaminophenyl)fluorene, 9,9-bis(3,5-diisopropyl-4-aminophenyl)fluorene, 9,9-bis(3-chloro-4-aminophenyl)fluorene, 9,9-bis(3,5-dichloro-4-aminophenyl)fluorene, 9,9-bis(3,5-diethyl-4-methylaminophenyl)fluorene, 9,9-bis(3,5-diethyl-4-aminophenyl)fluorene.

The 9,9-bis(aminophenyl)fluorene or derivative therefrom can form any suitable proportion of the provided curable composition based on the number of epoxide groups present in the epoxy resin. For example, the 9,9-bis(aminophenyl)fluorene or derivative therefrom can provide from 1 to 2 amino groups, 1.1 to 1.8 amino groups, or 1.2 to 1.6 amino groups per epoxide group in the epoxy resin. In some embodiments, the 9,9-bis(aminophenyl)fluorene or derivative therefrom can provide less than, equal to, or greater than 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95 or 2.0 amino groups per epoxide group in the epoxy resin.

The 9,9-bis(aminophenyl)fluorene or derivative therefrom can form any suitable weight fraction of the provided curable composition, such as 0.01 wt % to 10 wt %; 0.1 wt % to 7 wt %; 0.5 wt % to 3 wt %; or in some embodiments less than, equal to, or greater than 0.01 wt %, 0.05, 0.1, 0.2, 0.5, 0.7, 1, 1.5, 2, 2.5, 3, 3.5, 4, 4.5, 5, 6, 7, 8, 9, or 10 wt %, relative to the overall weight of the curable composition.

### Core Shell Particles

The provided curable compositions further contain a plurality of core shell particles dispersed therein. Core shell particles are filler particles having two or more distinct concentric parts—a core and at one or more shell layers surrounding the core. In some embodiments, the core is an elastomeric core and made from either a physically crosslinked or microphase-separated polymer, while the shell layer is made from a non-elastomeric glassy polymer. Advantageously, the rubbery, elastomeric core can enhance toughness in the cured resin composition, while the glassy polymeric shell can impart improved compatibility between the filler particle and the matrix component of the curable resin.

In various embodiments, the core shell particles have an average particle diameter that is sufficiently small to allow permeation into fibrous media when preparing fiber-reinforced composite materials. In exemplary composite applications, the core shell particles can have a particle diameter in the range of from 10 nm to 800 nm, from 50 nm to 500 nm, or from 80 nm to 300 nm, or in some embodiments, less than, equal to, or greater than 5 nm, 10, 20, 30, 40, 50, 70, 100, 200, 300, 400, 500, 600, 700, 800, 900, or 1000 nm.

The core shell particles may be uniformly dispersed in the composition, or at least partially aggregated. Aggregated core shell particles may be in physical contact with one or more other core shell particles. In some embodiments, the core shell particles form long chains of aggregated particles that extend across the bulk of the curable resin. Such aggregated core shell particle chains may be linear or branched. The core shell particle chains may themselves be uniformly distributed throughout the bulk of the curable resin. The configuration of such aggregates can be substantially preserved when the curable composition is cured.

The particle diameter distribution of the core shell particles can be monomodal or multimodal. A monomodal particle diameter distribution is characterized by a single peak (or mode) in a particle diameter distribution, while a multimodal distribution is characterized by two or more peaks in the particle diameter distribution. A multimodal distribution can be a bimodal distribution characterized by exactly two peaks, a trimodal distribution with exactly three peaks, and so forth.

In some embodiments, the multimodal distribution of the core shell particles has a first mode (as determined by transmission electron microscopy) characterized by a particle size “D1” in the range of from 120 nm to 500 nm, 160 nm to 425 nm, or 200 nm to 350 nm. In some embodiments, the particle size of the first mode is less than, equal to, or greater than 100 nm, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 nm.

A multimodal distribution of the core shell particles also displays a second mode characterized by a particle diameter “D2” less than that corresponding to the first mode. In some embodiments, D2 is in the range of from 30 nm to 200 nm, 40 nm to 150 nm, or 50 nm to 100 nm. In some embodiments, the particle size of the first mode is less than, equal to, or greater than, 30 nm, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or 200 nm.

As described herein, the first and second modes are defined relative to each other such that the particle diameter of the first mode D1 is greater than the particle diameter of the second mode, D2. In some embodiments, the ratio D1:D2, is at least 1.5:1, at least 2:1, at least 4:1, or at least 10:1. Generally, the ratio of D1:D2 is no greater than 10:1. In some embodiments, the ratio D1:D2 is less than, equal to, or greater than 1.5:1, 2:1, 3:1, 4:1, 5:1, 6:1, 7:1, 8:1, 9:1, or 10:1.

In some embodiments, the elastomeric core is comprised of a polymer having a low glass transition temperature enabling rubbery behavior, such as less than 0° C., or less than −30° C. More broadly, the glass transition temperature of the core polymer can be in the range of −100° C. to 25° C., −85° C. to 0° C., or −70° C. to −30° C., or in some embodiments, less than, equal to, or greater than −100° C., −95, −90, −85, −80, −75, −70, −65, −60, −55, −50, −45, −40, −35, −30, −25, −20, −15, −10, −5, 0, 5, 10, 15, 20, or 25° C.

Suitable core polymers broadly include various rubbers and polymers and copolymers of conjugated dienes, acrylates, and methacrylates. Such polymers can include, for example, homopolymers of butadiene or isoprene, or any of a number of copolymers of butadiene or isoprene with one or more ethylenically unsaturated monomers, which may include vinyl aromatic monomers, acrylonitrile, methacrylonitrile, acrylates, and methacrylates. Alternatively or in combination with the above, the core polymer could include a polysiloxane rubber-based elastomer.

The shell polymer need not be particularly restricted and can be comprised of any suitable polymer, including thermoplastic and thermoset polymers. Optionally, the shell polymer is crosslinked. In some embodiments, the shell polymer has a glass transition temperature greater than ambient temperature, i.e., greater than 25° C. The glass transition temperature of the shell polymer can be in the range of 30° C. to 170° C., 55° C. to 150° C., or 80° C. to 130° C.; or in some embodiments, less than, equal to, or greater than 30° C., 35, 40, 45, 50, 55, 60, 65, 70, 75, 80, 85, 90, 95, 100, 105, 110, 115, 120, 125, 130, 135, 140, 145, 150, 155, 160, 165, or 170° C.

Suitable shell polymers include polymers and copolymers of dienes, acrylates, methacrylates, vinyl monomers, vinyl cyanides, unsaturated acids and anhydrides, acrylamides, and methacrylamides. Specific examples of suitable shell polymers include, poly(methylmethacrylate), polystyrene, polyacrylonitrile, polyacrylic acid, and methylmethacrylate butadiene styrene copolymer.

The relative proportions of the core polymer and shell polymer in a given core shell particle need not be restricted. In some embodiments, the core represents on average 50 wt % to 95 wt % of the core shell particles while the outer shell represents or 5 wt % to 50 wt % of the core shell particles. In other embodiments, the outer shell layer represents on average from 0.2 wt % to 7 wt % of the core shell particle. In further embodiments, the outer shell layer represents on average less than, equal to, or greater than, 0.1 wt %, 0.2, 0.3, 0.4, 0.5, 0.7, 1, 2, 3, 4, 5, 6, 7, 8, 9, 10, 12, 15, 17, 20, 25, 30, 35, 40, 45, or 50 wt % of the core shell particle.

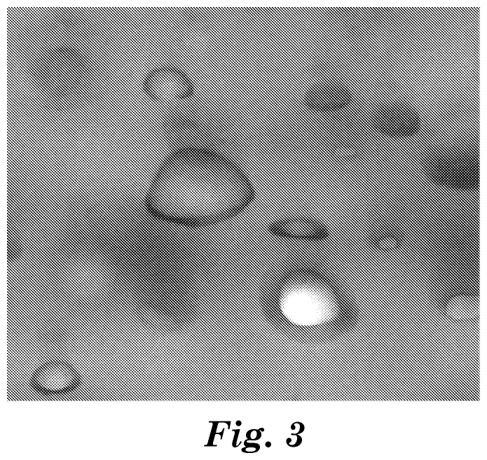

In some embodiments, each core shell particle includes one or more polymeric intermediate shell layers disposed between the elastomeric core and the outer shell layer. The introduction of an intermediate layer provides another way to tailor the chemical and physical properties of the core shell particles. It may be advantageous, for instance, to provide an intermediate layer that acts as a primer, or tie layer, that improves adhesion between the core polymer and outer shell polymer. Use of an intermediate layer can also help adjust the rheological properties of the composition while preserving particular interfacial characteristics between the outer shell polymer and matrix component of the curable composition. In various embodiments, the polymeric outer shell layer has a greater degree of unsaturation (e.g., having a greater density of double-bonds) than that of the polymeric intermediate layer. This aspect is shown by the transmission electron micrograph of FIG. 2 (also referred to in the Examples), in which the osmium tetroxide appears to preferentially stain the double-bond-rich outer shell of the core shell particles.

An intermediate layer, like the outer shell layer, may be polymerized in situ from any of a number of suitable monomers known in the art, including monomers useful for the outer shell layer. An intermediate layer can be, for example, derived from a polymer or copolymer of an acrylate, methacrylate, isocyanuric acid derivative, aromatic vinyl monomer, aromatic polycarboxylic acid ester, or combination thereof, while the outer shell layer can be, for example, derived from a polymer or copolymer of an acrylate, methacrylate, or combination thereof.

Dispersing core shell particles into a curable composition, and particularly a curable composition based on an epoxy resin, can improve the toughness of the cured composition in different ways. As an example, the core polymer can be engineered to cavitate on impact, which dissipates energy. Core shell particles can also intercept and impede the propagation of cracks and relieve stresses that are generated during the curing of the matrix resin material.

The core shell particles can be any proportion of the curable composition suitable to obtain the desired impact resistance after the composition is cured. In some embodiments, the core shell particles represent from 1 wt % to 25 wt %, 2 wt % to 20 wt %, or 5 wt % to 15 wt % of the curable composition, or in some embodiments, less than, equal to, or greater than 1 wt %, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt % of the curable composition.

In an exemplary embodiment, the curable composition is comprised of an 50:50 wt %:wt % blend of Bisphenol A and Bisphenol F epoxy resins, and 5 wt % of a core shell particle filler with a bimodal particle size distribution.

Core shell particles can be made using any known method. In one method, core shell particles are made by a graft polymerization method in which a shell monomer, such as a vinyl polymerizable monomer, is graft polymerized onto the surface of a crosslinked rubber core polymer whereby covalent bonds connect the core and shell layer. A similar method can be used to dispose an outer shell polymer onto an intermediate layer, which is in turn disposed on the crosslinked rubber core.

Preparation of the elastomeric cores of the core shell particles can take place using a seed emulsion polymerization method. In this process, a seed latex is initially prepared by emulsion polymerization and acts as nucleation sites for further polymerization. The seed latex particles are then subjected to a growth step in which they are swollen with additional monomer to grow the particles to a larger size, after which the monomer is polymerized. Further details concerning this process are described, for example, in U.S. Patent Publication No. 2009/0298969 (Attarwala et al.).

Suitable core shell particles having properties described therein are commercially available dispersions in an epoxy resin matrix, such as available from Kaneka North America LLC, Pasadena, Tex. Useful dispersions include, for example, Kaneka MX-120 (masterbatch of 25 wt % micro-sized core-shell rubber in a diglycidyl ether of bisphenol A matrix).

In preparing the curable composition, masterbatches of core shell particles can be conveniently diluted with epoxy resin as appropriate to obtain the desired loading. This mixture can then be mechanically mixed, optionally with any remaining component or components of the curable composition.

### Inorganic Sub-Micron Particles

As a further option, the provided curable compositions can contain any of a variety of known inorganic sub-micron particles (including nanoparticles) known in the art. It was found that the inclusion of small amounts of inorganic sub-micron particles can provide a significant increase of modulus in the cured composition. Advantageously, this increase in modulus can partially or fully offset the decrease in modulus attributable to the presence of core shell particles in the curable composition while preserving the high degree of fracture toughness imparted by the core shell particles.

Useful sub-micron particles can include surface-bonded organic groups that serve to improve compatibility between the inorganic sub-micron particles and the epoxy resin. Useful sub-micron particles include sub-micron particles derived from silicon dioxide (i.e., silica) and calcium carbonate.

The size of the sub-micron particles need not be particularly restricted. In some embodiments, however, at least 50%, 55, 60, 65, 70, 75, 80, 85, 90, 95, 96, 97 or 98% of the calcite cores have a number average particle diameter of at most 400 nm.

In some embodiments, the surface-modified sub-micron particles comprise silica cores where at least a portion of the core surfaces have a surface-modifying agent bonded thereto. Advantageously, the surface-modifying agent aids in the dispersibility of the sub-micron particles in the epoxy resin. Surface modification can be achieved using various methods known in the art, such as described in U.S. Pat. No. 2,801,185 (Iler) and U.S. Pat. No. 4,522,958 (Das et al.).

Any of a number of surface-modifying agents can be used in the provided curable compositions. For example, silica sub-micron particles can be treated with monohydric alcohols, polyols, or mixtures thereof (preferably, a saturated primary alcohol) under conditions such that silanol groups on the surface of the particles chemically bond with hydroxyl groups to produce surface-bonded ester groups. The surface of silica (or other metal oxide) particles can also be treated with organosilanes, including alkyl chlorosilanes, trialkoxy arylsilanes, trialkoxy alkylsilanes, or organotitanates. Such compounds can be capable of attaching to the surface of the particles by a chemical bond (covalent or ionic) or by a strong physical bond, while being chemically compatible with the epoxy resin. When aromatic ring-containing epoxy resins are utilized, aromatic surface treatment agents can be chosen for improved compatibility with the resin.

In an exemplary method of dispersing silica into a curable resin, a silica hydrosol is combined with a water-miscible organic liquid (e.g., an alcohol, ether, amide, ketone, or nitrile) and a surface treatment agent such as an organosilane or organotitanate. Preferably, the amount of alcohol and/or treatment agent is selected so as to provide particles having at least 50 wt %, at least 60 wt %, or at least 75 wt %, silica. The resulting mixture can then be heated to remove water by distillation or by azeotropic distillation and can then be maintained at an elevated temperature for a time period sufficient to enable the reaction of the surface treatment agent with chemical groups on the surface of the sub-micron particles. This provides an organosol comprising sub-micron particles which have surface-attached or surface-bonded organic groups.

The resulting organosol can then be mixed with a curable resin and the organic liquid stripped away via heat and/or vacuum. Stripping times and temperatures can be selected to maximize removal of volatiles while minimizing advancement of the resin. Removal of volatiles at this stage helps avoid void formation during the curing of the composition, which can degrade the ultimate physical properties of the cured composites. For resin transfer molding applications, it is desirable for resin sols to have volatile levels less than about 2 wt %, and preferably less than about 1.5 wt %, to provide void-free composites having the desired thermomechanical properties.

Further details associated with surface-modified silica sub-micron particles for use in composite materials can be found in U.S. Pat. No. 5,648,407 (Goetz et al.).

In alternative embodiments, the surface-modified sub-micron particles comprise calcite cores and a surface-modifying agent bonded to the calcite. Calcite is the crystalline form of calcium carbonate and typically forms rhombohedral crystals.

The surface-modifying agents for calcite can include both a binding group and a compatibilizing group to improve compatibility between the calcite sub-micron particles and the curable resin. The binding group can have, for example, a bond energy of at least 0.70 electron volts to calcite as calculated using the Binding Energy Calculation Procedure described in U.S. Patent Publication No. 2012/0244338 (Schultz et al). Exemplary binding groups include phosphonic acids, sulfonic acids, and combinations thereof. Useful compatibilizing groups include polymeric species that are compatible with the curable resin. For epoxy resins, these can include polyalkylene oxides, such as polypropylene oxide and polyethylene oxide, polyesters, and combinations thereof.

In some embodiments, the compatibilizing group may be selected to provide a positive enthalpy of mixing for the composition containing the surface-modified sub-micron particles and the curable resin. The materials, for example, can be selected such that the difference in these solubility parameters is no more than 4 J^{1/2} cm^{-3/2} and, in some embodiments, no more than 2 J^{1/2} cm^{-3/2} as determined according to Properties of Polymers; Their Correlation with Chemical Structure; Their Numerical Estimation and Prediction from Additive Group Contributions, third edition, edited by D. W. Van Krevelen, Elsevier Science Publishers B. V., Chapter 7, 189-225 (1990)), hereinafter referred to as the “Solubility Parameter Procedure.”

The binding group bonds to the calcite, connecting the surface-modifying agent to the calcite core. Unlike many silica-based sub-micron particle systems wherein the surface-modifying agents are covalently bonded to the silica, the surface-modifying agents of the present disclosure are ionically bonded to (e.g., associated with) the calcite.

In order to retain the surface-modifying agents with the calcite cores during processing of the compositions, it may be desirable to select binding groups having high bond energies to calcite. Bond energies can be predicted using density functional theory calculations. In some embodiments, the calculated bond energies may be at least 0.6, e.g., at least 0.7 electron volts. Generally, the greater the bond energy the greater the likelihood that the binding group will remain ionically associated with the particle surface. In some embodiments, the binding group has a bond energy of greater than 0.8 electron volts, 0.81, 0.82, 0.83, 0.84, 0.85, 0.86, 0.87, 0.88, 0.89, 0.9, 0.91, 0.92, 0.93, 0.94, or 0.95 electron volts.

As a further option, the first surface-modifying agent can further comprise a reactive group capable of reacting with the curable resin. In some embodiments, the surface-modifying agent is a zwitterion—i.e., a molecule that is neutral overall but having separate positively and negatively charged groups at different locations within the molecule. In some embodiments, the surface-modifying agent comprises a polyetheramine.

Further options and advantages associated with surface-modified calcite sub-micron particles are described in U.S. Pat. No. 9,221,970 (Schultz et al.).

The inorganic sub-micron particles dispersed in the curable composition can have any suitable diameter. For example, the average overall diameter of the inorganic sub-micron particles can be in the range of from 5 nm to 400 nm; from 10 nm to 200 nm; from 20 nm to 150 nm; or in some embodiments, less than, equal to, or greater than 5 nm, 10, 15, 20, 25, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 nm.

Curable compositions containing particulate fillers having sub-micron dimensions, such as nanoscale dimensions, can be highly advantageous when producing fibrous composites. Use of core shell particles and inorganic particulate filler with a sufficiently small diameter can impart the benefits of increased fracture toughness, increased modulus (i.e., stiffness), or both, without being filtered out when injected through a matrix of reinforcing fibers. As a result, the provided curable compositions can tolerate being pressurized through a highly compressed fiber array in a resin transfer molding process used to make a continuous fiber composite. This in turn enables a macroscopically uniform distribution of particles and resin throughout the final composite and improved performance properties.

The inorganic sub-micron particles can be present in an amount appropriate to provide an improvement in the strength to weight ratio of the cured composition when used in an application such as a coating or fiber-reinforced composite. The inorganic sub-micron particles can be present, for example, in an amount of from 2 wt % to 50 wt %; 10 w t % to 40 wt %; 10 wt % to 30 wt %; or in some embodiments, less than, equal to, or greater than 2 wt %, 3, 4, 5, 8, 10, 12, 15, 17, 20, 25, 30, 35, 40, 45, 50, 55, 60, 65, or 70 wt %, based on the overall weight of the curable composition.

### Cured Composition Properties

It is preferable for the curable composition, once cured, to have a glass transition temperature that is sufficiently high to handle application with extreme operational temperatures. In some embodiments, the cured composition displays a glass transition temperature T_{g} of from 80° C. to 300° C.; from 120° C. to 250° C.; from 150° C. to 190° C.; or less than, equal to, or greater than, 70° C., 80, 90, 100, 110, 120, 130, 140, 150, 160, 170, 180, 190, 200, 210, 220, 230, 240, 250, 260, 270, 280, 290, 300, 310, 320, 330, 340, or 350° C.

At the same time, the cured composition should have sufficient fracture toughness to withstand impacts that could result from a catastrophic event, such as the fragmentation of a jet engine fan blade. The cured composition can display a fracture toughness threshold K_{IC} of from 1.4 MPa-m^{1/2} to 4.0 MPa-m^{1/2}; from 1.6 MPa-m^{1/2} to 4.0 MPa-m^{1/2}; from 1.8 MPa-m^{1/2} to 4.0 MPa-m^{1/2}; or in some embodiments, less than, equal to, or greater than, 1.1 MPa-m^{1/2}, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 MPa-m^{1/2}.

Cured fiber-reinforced composites can be prepared by combining the curable compositions with a plurality of embedded fibers. In various embodiments, these embedded fibers are continuous reinforcing fibers, which can be organic fibers, inorganic fibers, or mixtures thereof. Exemplary organic and inorganic fibers include carbon and graphite fibers, glass fibers, ceramic fibers, boron fibers, silicon carbide fibers, polyimide fibers, polyamide fibers, polyethylene fibers, and the like, and mixtures thereof. Such fibers can be in the form of a unidirectional array of individual continuous fibers, woven fabric, knitted fabric, yarn, roving, braided constructions, or non-woven mat. Generally, cured composite compositions can contain, from 30 vol % to 80 vol % fibers, from 45 vol % to 70 vol % fibers, or in some embodiments, less than, equal to, or greater than, 25 vol %, 30, 35, 40, 45, 50, 55, 60, 65, 70, 75, or 80 vol % fibers, depending upon the demands of the structural application at hand.

Resin transfer molding is a known method that may be used to fabricate a fiber-reinforced composite from the provided curable compositions. Resin transfer molding is a closed-mold, vacuum-assisted process in which a fiber preform or dry fiber-reinforcement is packed into a mold cavity that has the shape of the desired part. After closing and clamping the mold, the curable composition is pumped into the mold under pressure, displacing the air at the edges, until the mold is filled. The composition may be heated to further reduce its viscosity. After the mold is filled, the cure cycle takes place, in which the mold is heated to higher temperatures where the composition cured. Finally, after curing, the rigid finished part can be cooled and released from the mold.

Fiber-reinforced composite materials can be used in any of a number of surfacing assemblies. One useful surfacing assembly could be made, for example, by coating an adhesive layer onto the surface film made from any of the fiber-reinforced composites above. The adhesive layer could be, in some cases, a pressure-sensitive adhesive and may form an adhesive bond that is either temporary or permanent. Particularly suitable applications for these fiber-reinforced composite materials include aircraft engine components, which have stringent requirements for impact resistance.

While not intended to be exhaustive, further embodiments are presented below:
1. A curable composition comprising: epoxy resin; a 9,9-bis(aminophenyl)fluorene or derivative therefrom; and core shell particles, each comprising an elastomeric core and a polymeric outer shell layer coated on the elastomeric core; wherein the core shell particles are at least partially aggregated with each other.
2. A curable composition comprising: epoxy resin; a 9,9-bis(aminophenyl)fluorene or derivative therefrom; and core shell particles, each comprising: an elastomeric core; a polymeric intermediate layer disposed on the elastomeric core; and a polymeric outer shell layer disposed on the polymeric intermediate layer, the polymeric outer shell layer having a greater degree of unsaturation than that of the polymeric intermediate layer.
3. The curable composition of embodiment 2, wherein the polymeric intermediate layer is derived from a first monomer comprising a polymer or copolymer of an acrylate, methacrylate, isocyanuric acid derivative, aromatic vinyl monomer, aromatic polycarboxylic acid ester, or combination thereof, and wherein the polymeric outer shell layer is derived from a second monomer comprising a polymer or copolymer of an acrylate, methacrylate, or combination thereof
4. The curable composition of embodiment 2 or 3, wherein the core shell particles are at least partially aggregated with each other.
5. A curable composition comprising: epoxy resin; a 9,9-bis(aminophenyl)fluorene or derivative therefrom; and core shell particles, each comprising an elastomeric core and a polymeric outer shell layer disposed on the elastomeric core; wherein the core shell particles have a multimodal particle diameter distribution.
6. The curable composition of embodiment 5, wherein the core shell particles have a bimodal particle diameter distribution.
7. The curable composition of embodiment 5 or 6, wherein the particle diameter distribution includes: a first mode having an average particle diameter D1 of from 120 nm to 500 nm; and a second mode having an average particle diameter D2 of from 30 nm to 200 nm.
8. The curable composition of embodiment 7, wherein the average particle diameter D1 is of from 160 nm to 425 nm and the average particle diameter D2 is from 40 nm to 150 nm.
9. The curable composition of embodiment 8, wherein the average particle diameter D1 is of from 200 nm to 350 nm and the average particle diameter D2 is from 50 nm to 100 nm.
10. The curable composition of any one of embodiments 5-9, wherein the core shell particles are at least partially aggregated with each other.
11. The curable composition of any one of embodiments 5-10, wherein each core shell particle further comprises a polymeric intermediate layer disposed between the elastomeric core and the outer shell layer, the polymeric outer shell layer having a greater degree of unsaturation than that of the polymeric intermediate layer.
12. A curable composition comprising: epoxy resin; a 9,9-bis(aminophenyl)fluorene or derivative therefrom; core shell particles, each comprising an elastomeric core and a polymeric outer shell layer coated on the elastomeric core; and inorganic sub-micron particles dispersed in the curable composition, the inorganic sub-micron particles having surface-bonded organic groups that compatibilize the inorganic sub-micron particles and the epoxy resin.
13. The curable composition of embodiment 12, wherein the inorganic sub-micron particles comprise silica sub-micron particles.
14. The curable composition of embodiment 12 or 13, wherein the inorganic sub-micron particles have an overall average diameter in the range of from 5 nm to 400 nm.
15. The curable composition of embodiment 14, wherein the inorganic sub-micron particles have an overall average diameter in the range of from 10 nm to 200 nm.
16. The curable composition of embodiment 15, wherein the inorganic sub-micron particles have an overall average diameter in the range of from 20 nm to 150 nm.
17. The curable composition of any one of embodiments 12-16, wherein the inorganic sub-micron particles are present in an amount of from 2 wt % to 50 wt %, based on the overall weight of the curable composition.
18. The curable composition of embodiment 17, wherein the inorganic sub-micron particles are present in an amount of from 6 wt % to 40 wt %, based on the overall weight of the curable composition.
19. The curable composition of embodiment 18, wherein the inorganic sub-micron particles are present in an amount of from 10 wt % to 30 wt %, based on the overall weight of the curable composition.
20. The curable composition of embodiment 12, wherein each inorganic sub-micron particle comprises: a calcite core; a first surface-modifying agent bonded to the calcite core, the first surface-modifying agent comprising a binding group ionically bonded to the calcite core and a compatibilizing group compatible with the epoxy resin, wherein the binding group comprises a phosphonic acid, a sulfonic acid, a phosphoric acid, or a combination thereof, and further wherein the compatibilizing group comprises at least one of a polyethylene oxide, a polypropylene oxide, and a polyester.
21. The curable composition of embodiment 20, wherein at least 90% of the calcite cores have a size of at most 400 nm.
22. The curable composition of embodiment 20 or 21, wherein the binding group has a bond energy of at least 0.70 electron volts to calcite as determined using the Binding Energy Calculation Procedure, assuming a calcium rich surface.
23. The curable composition of any one of embodiments 20-22, wherein the difference between the solubility parameter of the curable resin and the solubility parameter of the compatibilizing group, as determined according to the Solubility Parameter Procedure, is no more than 4 J^{1/2} cm^{-3/2}.
24. The curable composition of any one of embodiments 20-23, wherein the first surface-modifying agent further comprises a reactive group capable of reacting with the epoxy resin.
25. The curable composition of any one of embodiments 12-24, wherein the core shell particles are at least partially aggregated with each other.
26. The curable composition of any one of embodiments 12-25, wherein each core shell particle further comprises a polymeric intermediate layer disposed between the elastomeric core and the outer shell layer, the polymeric outer shell layer having a greater degree of unsaturation than that of the polymeric intermediate layer.
27. The curable composition of any one of embodiments 12-26, wherein the core shell particles have a multimodal particle diameter distribution.
28. The curable composition of any one of embodiments 1-27, wherein the core shell particles are present in an amount of from 1 wt % to 25 wt %, based on the overall weight of the curable composition.
29. The curable composition of embodiment 28, wherein the core shell particles are present in an amount of from 2 wt % to 20 wt %, based on the overall weight of the curable composition.
30. The curable composition of embodiment 29, wherein the core shell particles are present in an amount of from 5 wt % to 15 wt %, based on the overall weight of the curable composition.
31. The curable composition of any one of embodiments 1-30, where the elastomeric core comprises a silicone rubber or polymer or copolymer of a conjugated diene, acrylate, or methacrylate.
32. The curable composition of any one of embodiments 1-31, wherein the elastomeric core has a glass transition temperature of at most 0° C.
33. The curable composition of embodiment 32, wherein the elastomeric core has a glass transition temperature of at most −30° C.
34. The curable composition of any one of embodiments 1-33, wherein the polymeric outer shell layer comprises a polymer or copolymer of butadiene, acrylate, methacrylate, vinyl chloride, styrene, or combination thereof.
35. The curable composition of embodiment 34, wherein the polymeric outer shell layer comprises methylmethacrylate butadiene styrene copolymer.
36. The curable composition of embodiment 34 or 35, wherein the polymer or copolymer of the polymeric outer shell layer is at least partially crosslinked.
37. The curable composition of any one of embodiments 1-36, wherein the polymeric outer shell layer represents on average from 0.2 wt % to 7 wt % of the core shell particles, based on the overall weight of the core shell particles.
38. The curable composition of any one of embodiments 1-37, wherein the epoxy resin comprises bisphenol A epoxy resin.
39. The curable composition of any one of embodiments 1-38, wherein the epoxy resin comprises bisphenol E epoxy resin.
40. The curable composition of any one of embodiments 1-39, wherein the epoxy resin comprises bisphenol F epoxy resin.
41. The curable composition of any one of embodiments 1-40, wherein the epoxy resin comprises a fluorene epoxy resin.
42. The curable composition of any one of embodiments 1-41, wherein the core shell particles have an average diameter in the range of from 50 nm to 500 nm.
43. The curable composition of embodiment 42, wherein the core shell particles have an average diameter in the range of from 100 nm to 400 nm.
44. The curable composition of embodiment 43, wherein the core shell particles have an average diameter in the range of from 100 nm to 300 nm.
45. The curable composition of any one of embodiments 1-44, wherein the 9,9-bis(aminophenyl) fluorene derivative comprises 9,9-bis(3-methyl-4-aminophenyl)fluorene; 9,9-bis(3-ethyl-4-aminophenyl)fluorene; 9,9-bis(3-phenyl-4-aminophenyl)fluorene; 9,9-bis(3,5-dimethyl-4-aminophenyl)fluorene; 9-(3,5-diethyl-4-aminophenyl)-9-(3-methyl-4-aminophenyl)fluorene; 9-(3-methyl-4-aminophenyl)-9-(3-chloro-4-aminophenyl)fluorene; 9,9-bis(3,5-diisopropyl-4-aminophenyl)fluorene; or 9,9-bis(3-chloro-4-aminophenyl)fluorene.
46. The curable composition of any one of embodiments 1-45, wherein the 9,9-bis(aminophenyl)fluorene or derivative therefrom is present in an amount sufficient to provide from 1 to 2 amino groups per epoxide group in the epoxy resin.
47. The curable composition of embodiment 46, wherein the 9,9-bis(aminophenyl)fluorene or derivative therefrom is present in an amount sufficient to provide from 1.1 to 1.8 amino groups per epoxide group in the epoxy resin.
48. The curable composition of embodiment 47, wherein the 9,9-bis(aminophenyl)fluorene or derivative therefrom is present in an amount sufficient to provide from 1.2 to 1.6 amino groups per epoxide group in the epoxy resin.
49. A cured composition obtained by curing the curable composition of any one of embodiments 1-48.
50. The cured composition of embodiment 49, wherein the cured composition displays a glass transition temperature T_{g} of from 80° C. to 300° C.
51. The cured composition of embodiment 50, wherein the cured composition displays a glass transition temperature T_{g} of from 120° C. to 250° C.
52. The cured composition of embodiment 51, wherein the cured composition displays a glass transition temperature T_{g} of from 150° C. to 190° C.
53. The cured composition of any one of embodiments 49-52, wherein the cured composition displays a fracture toughness threshold K_{IC} of at least 1.4 MPa-m^{1/2}.
54. The cured composition of embodiment 53, wherein the cured composition displays a fracture toughness threshold K_{IC} of at least 1.6 MPa-m^{1/2}.
55. The cured composition of embodiment 54, wherein the cured composition displays a fracture toughness threshold K_{IC} of at least 1.8 MPa-m^{1/2}.
56. A fiber-reinforced composite comprising: the cured composition of any one of embodiments 49-55; and a plurality of carbon fibers embedded in the cured composition.
57. A surfacing assembly comprising: a surface film comprising the fiber-reinforced composite of embodiment 56; and an adhesive layer disposed on the surface film.

### EXAMPLES

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all reagents were obtained or are available from Sigma-Aldrich Company, St. Louis, Mo., or may be synthesized by known methods. Unless otherwise reported, all ratios are by weight percent and all preparation and testing were conducted at ambient temperature.

The following abbreviations are used to describe the examples:

° C.: degrees Centigrade

cm: centimeter

g/m²: grams per square meter

IR: infrared

K_{IC}: fracture toughness

kPa: kiloPascal

L: liter

mm: millimeter

mm Hg: millimeters mercury

μm: micrometer

MPa·m^{0.5}: megapascal square root meter

m/s: meters per second

nm: nanometer

rpm: revolutions per minute

wt. %: weight percent

CAF: 9,9-bis(3-chloro-4-aminophenyl)fluorene powder, obtained from WeylChem US Inc., Elgin, S.C.
DER-332: A liquid epoxy resin, obtained under the trade designation “D.E.R. 332” from Dow Chemical Company, Midland, Mich.
MX-150: A 40% concentrate of core shell rubber toughening agent in liquid epoxy resin based on Bisphenol A, obtained under the trade designation “MX-150” from Kaneka North America, LLC, Pasadena, Tex.
MX-154: A 40% concentrate of core shell rubber toughening agent in liquid epoxy resin based on Bisphenol A, obtained under the trade designation “MX-154” from Kaneka North America, LLC.
MX-257: A 37% concentrate of core shell rubber toughening agent in liquid epoxy resin based on Bisphenol A, obtained under the trade designation “MX-257” from Kaneka North America, LLC.

### Cast Resin (CR) Examples

A resin cast mold was prepared as follows. Two glass plates measuring 7 by 10 by 0.25 inches (17.78 by 25.40 by 0.64 cm) were coated on one face with a mold release, type “FREKOTE 55-NC” from Loctite Corporation, Rocky Hill, Conn. The coated faces of the glass plates were then superposed and separated along three sides by 0.75 by 0.25 inch (1.91 by 0.64 cm) strips of Teflon™, the strips flush with the perimeter of the glass plates. The resulting glass mold assembly, having cavity dimensions of 8.5 by 6.25 by 0.25 inches (21.59 by 15.88 by 0.64 cm) was held together by means of bulldog clips.

### Comparative A

To a steel quart (0.95 L) can was added 30.40 grams MX-257, 99.13 grams DER-332 and 95.45 grams CAF at 21° C. The contents were placed on a hot plate and stirred with an air motor powered overhead stirrer until the resin reached 320° F. (160° C.), as measured by an IR thermometer. The liquid resin was then poured through an 80 mesh (180 μm) steel screen, to remove any solid contaminants, into another steel quart (0.95 L) size can and placed in a glass desiccator under vacuum in order to degas the resin. After approximately 10 minutes, the resin was removed from the desiccator and poured into a pre-heated glass mold at 375° F. (190.6° C.). The mold was placed in an oven for 2 hours at 375° F. (190.6° C.), after which the oven was switched off and the mold allowed to cool to 70° F. (21.1° C.), approximately 2 hours.

### Comparatives B-C and Examples 1-7

The procedure generally described for preparing cast resin Comparative A was repeated, according to the compositions listed in Table 1.

TABLE 1

| | | | Composition | | | |
|---|---|---|---|---|---|---|
| | Core-Shell | | Core- | | | Core |
| | | wt % | Shell | DER332 | CAF | Shell |
| Cast Resin | Type | Solids | (grams) | (grams) | (grams) | (wt. %) |
| Compar- | MX257 | 37.0 | 13.51 | 43.30 | 43.19 | 5.0 |
| ative A | | | | | | |
| Compar- | MX257 | 37.0 | 13.51 | 40.82 | 45.67 | 5.0 |
| ative B | | | | | | |
| Compar- | MX257 | 37.0 | 13.51 | 39.30 | 47.19 | 5.0 |
| ative C | | | | | | |
| Example 1 | MX154 | 40.0 | 12.50 | 41.74 | 45.76 | 5.0 |
| Example 2 | MX150 | 40.0 | 12.50 | 41.77 | 45.73 | 5.0 |
| Example 3 | MX154 | 40.0 | 12.50 | 39.48 | 48.02 | 5.0 |
| Example 4 | MX154 | 40.0 | 18.75 | 34.59 | 46.66 | 7.5 |
| Example 5 | MX154 | 40.0 | 25.00 | 29.70 | 45.30 | 10.0 |
| Example 6 | MX154 | 40.0 | 25.00 | 31.10 | 43.90 | 10.0 |
| Example 7 | MX154 | 40.0 | 25.00 | 30.39 | 44.61 | 10.0 |

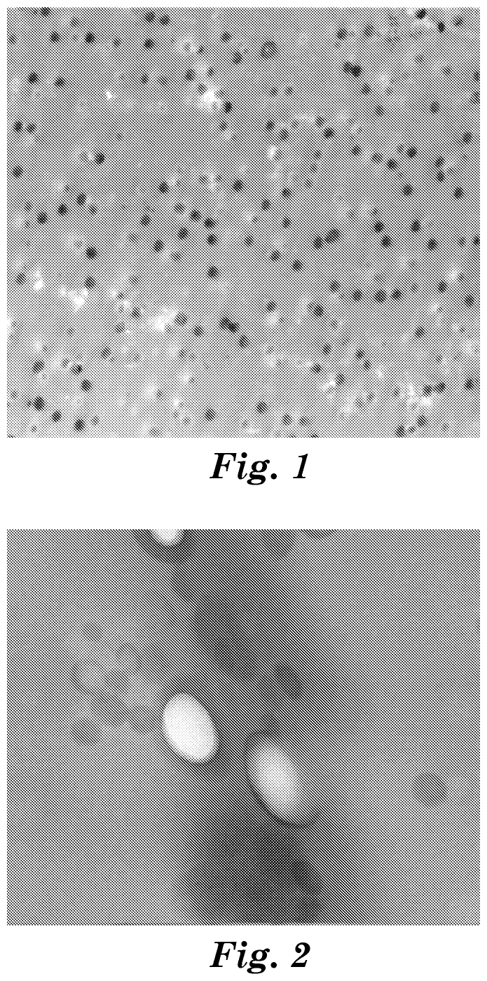

Transmission electron microscopy was used to image the embedded core-shell particles in the cured resin samples. The micrographs in FIGS. 1, 2, and 3 correspond to bright-field image micrographs of Comparative A, Example 2, and Example 3, respectively.

### Comparative D

A carbon fiber laminate, having the same cast resin composition as Comparative A, was prepared as follows. To a 300 gram speed mixer cup was added 40.54 grams MX-257 and 129.89 grams DER-332 at 21° C. Using a tongue depressor, 129.57 grams CAF was then manually stirred into the liquids until all of the CAF powder was wet out. The mixture was then homogeneously dispersed by means of a model “DAC 600” SpeedMixer, from FlackTek, Inc., Landrum, S.C., for 1.5 minutes at 2,000 rpm, using a tongue depressor to incorporate all of the contents into the bulk of the resin. The cup was then vacuum speed mixed at 690 mm Hg (92.0 kPa) for 2.5 minutes at 2,000 rpm to remove entrapped air. A 13 by 13 inch (33.02 by 33.02 cm) laminate of 370 g/m², 8-harness, satin weave carbon fiber fabric, obtained from Hexcel Corporation, Stamford, Conn., was assembled in a 9-ply, 0/90 degree orientation in a resin transfer mold. The resin composition was then injected into the mold at 165° C., a vacuum of approximately 0.1 Torr (13.3 Pa) applied for 30 minutes, after which the laminate was cured for 2 hours at 375° F. (190.6° C.). The resultant carbon fiber laminate, approximately 3.175 mm thick, was cut into four equal size sections of 15.2 by 15.2 cm using a water cooled diamond saw, patted dry and sealed in a plastic bag until tested.

### Comparatives E-F and Examples 8-14

The procedure generally described for preparing carbon fiber laminate Comparative D was repeated, according to the cast resins listed in Table 3.

### Test Methods

### Fracture Toughness

The cast resin examples and comparatives were evaluated for fracture toughness in terms of critical stress intensity factor, K_{IC}, at 21° C., −20° C. and −50° C. according to ASTM D5045. K_{IC} values reported in Table 2 represent an average of 10 cast resins per Example.

TABLE 2

| | Fracture Toughness | | |
|---|---|---|---|
| | K_{IC} (MPa · m^{0.5}) | | |
| Example | @ 21° C. | @ −20° C. | @ −50° C. |
| Comparative A | 1.17 | N/A | N/A |
| Comparative B | 1.30 | N/A | N/A |
| Comparative C | 1.38 | N/A | N/A |
| Example 2 | 1.41 | 1.41 | 1.37 |
| Example 4 | 1.70 | 1.51 | 1.54 |
| Example 5 | 1.92 | N/A | 1.64 |
| Example 6 | 1.77 | N/A | 1.60 |

### Ballistic Test

The carbon fiber laminate, having a 4-inch (10.16 cm) diameter exposed surface, was clamped to metal fixture, perpendicular to the ballistic projectile direction. The projectiles were 8.0 gram, 9 mm diameter, full-metal-jacket, round-nose cylinders, obtained from Hornady Manufacturing Company, Grand Island, Nebr. A computer controlled gas gun was used to fire the projectile at an impact velocity of approximately 250 m/s, as measured by a chronograph. Simultaneously, a high-speed video camera was used to record the projectile impact. Residual velocity (V_{residual}) represents the projectile speed after penetrating the laminate. If the projectile failed to penetrate the laminate, the residual velocity was recorded as zero. The Predicted Ballistic Limit (PDL) for each laminate was calculated using the empirical equation:

V_{residual}=β(V_{impact}^{V}−V_{ballistic limit}^{V})^{1/F},

where V_{ballistic} is the ballistic limit velocity, an indicator of the laminate's ballistic property, β and p are parameters determined by curve fitting. The experimental data is fitted with this equation to determine the ballistic limit velocity for each composition by minimizing the differences between the predicted and measured residual velocities. Table 3 lists the ballistic test results of four carbon fiber laminates per Example.

TABLE 3

| | | Ballistic Impact Test | | |
|---|---|---|---|---|
| | | Impact | Residual | Predicted |
| Carbon Fiber | | Velocity | Velocity | Ballistic Limit |
| Laminate | Cast Resin | (m/s) | (m/s) | (m/s) |
| Comparative D | Comparative A | 253 | 140 | 225 |
| | | 244 | 160 | |
| | | 237 | 110 | |
| | | 225 | 0 | |
| Comparative E | Comparative B | 239 | 0 | 249 |
| | | 247 | 0 | |
| | | 254 | 119 | |
| | | 249 | 66 | |
| Comparative F | Comparative C | 253 | 0 | 261 |
| | | 255 | 0 | |
| | | 260 | 0 | |
| | | 265 | 124 | |
| Example 8 | Example 1 | 257 | 0 | 263 |
| | | 266 | 75 | |
| | | 258 | 0 | |
| | | 255 | 0 | |
| Example 9 | Example 2 | 252 | 0 | 263 |
| | | 263 | 0 | |
| | | 260 | 0 | |
| | | 269 | 176 | |
| Example 10 | Example 3 | 264 | 97 | 262 |
| | | 271 | 151 | |
| | | N/A | N/A | |
| | | N/A | N/A | |
| Example 11 | Example 4 | 264 | 0 | 266 |
| | | 266 | 0 | |
| | | 272 | 187 | |
| | | 271 | 180 | |
| Example 12 | Example 5 | 263 | 0 | 270 |
| | | 271 | 0 | |
| | | 274 | 136 | |
| | | 270 | 56 | |
| Example 13 | Example 6 | 265 | 0 | 271 |
| | | 268 | 0 | |
| | | 274 | 152 | |
| | | 271 | 0 | |
| Example 14 | Example 7 | 260 | 30 | 259 |
| | | 252 | 0 | |
| | | 257 | 0 | |
| | | 263 | 0 | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A curable composition comprising:
epoxy resin;
a 9,9-bis(aminophenyl)fluorene or derivative therefrom; and
core shell particles, each comprising an elastomeric core and a polymeric outer shell layer coated on the elastomeric core;
wherein the core shell particles are at least partially aggregated with each other.

2. A curable composition comprising:
epoxy resin;
a 9,9-bis(aminophenyl)fluorene or derivative therefrom; and
core shell particles, each comprising:
an elastomeric core;
a polymeric intermediate layer disposed on the elastomeric core; and
a polymeric outer shell layer disposed on the polymeric intermediate layer, the polymeric outer shell layer having a greater degree of unsaturation than that of the polymeric intermediate layer.

3. The curable composition of claim 2, wherein the polymeric intermediate layer is derived from a first monomer comprising a polymer or copolymer of an acrylate, methacrylate, isocyanuric acid derivative, aromatic vinyl monomer, aromatic polycarboxylic acid ester, or combination thereof, and wherein the polymeric outer shell layer is derived from a second monomer comprising a polymer or copolymer of an acrylate, methacrylate, or combination thereof.

4. A curable composition comprising:
epoxy resin;
a 9,9-bis(aminophenyl)fluorene or derivative therefrom; and
core shell particles, each comprising an elastomeric core and a polymeric outer shell layer disposed on the elastomeric core;
wherein the core shell particles have a multimodal particle diameter distribution.

5. The curable composition of claim 4, wherein the particle diameter distribution includes:
a first mode having an average particle diameter D1 of from 120 nm to 500 nm; and
a second mode having an average particle diameter D2 of from 30 nm to 200 nm.

6. The curable composition of claim 1, further comprising
inorganic sub-micron particles dispersed in the curable composition, the inorganic sub-micron particles having surface-bonded organic groups that compatibilize the inorganic sub-micron particles and the epoxy resin.

7. The curable composition of claim 6, wherein each inorganic sub-micron particle comprises:
a calcite core;
a first surface-modifying agent bonded to the calcite core, the first surface-modifying agent comprising a binding group ionically bonded to the calcite core and a compatibilizing group compatible with the epoxy resin, wherein the binding group comprises a phosphonic acid, a sulfonic acid, a phosphoric acid, or a combination thereof, and further wherein the compatibilizing group comprises at least one of a polyethylene oxide, a polypropylene oxide, and a polyester.

8. The curable composition of claim 7, wherein at least 90% of the calcite cores have a size of at most 400 nm.

9. The curable composition of claim 1, wherein the polymeric outer shell layer comprises a polymer or copolymer of butadiene, acrylate, methacrylate, vinyl chloride, styrene, or combination thereof and further wherein the polymer or copolymer of the polymeric outer shell layer is at least partially crosslinked.

10. The curable composition of claim 1, wherein the polymeric outer shell layer represents on average from 0.2 wt % to 7 wt % of the core shell particles, based on the overall weight of the core shell particles.

11. The curable composition of claim 1, wherein the epoxy resin comprises a fluorene epoxy resin.

12. The curable composition of claim 1, wherein the 9,9-bis(aminophenyl) fluorene derivative comprises 9,9-bis(3-methyl-4-aminophenyl)fluorene; 9,9-bis(3-ethyl-4-aminophenyl)fluorene; 9,9-bis(3-phenyl-4-aminophenyl)fluorene; 9,9-bis(3,5-dimethyl-4-aminophenyl)fluorene; 9-(3,5-diethyl-4-aminophenyl)-9-(3-methyl-4-aminophenyl)fluorene; 9-(3-methyl-4-aminophenyl)-9-(3-chloro-4-aminophenyl)fluorene; 9,9-bis(3,5-diisopropyl-4-aminophenyl)fluorene; or 9,9-bis(3-chloro-4-aminophenyl)fluorene.

13. A cured composition obtained by curing the curable composition of claim 1.

14. A fiber-reinforced composite comprising:
the cured composition of claim 13; and
a plurality of carbon fibers embedded in the cured composition.

15. A surfacing assembly comprising:
a surface film comprising the fiber-reinforced composite of claim 14; and
an adhesive layer disposed on the surface film.
